(19) United States
(12) Patent Application Publication
(10) Pub. No.: US 2012/0152810 A1
(43) Pub. Date: Jun. 21, 2012

(54) Method for Sorting by Means of Air Bursts and Correspondence Sorting Device

(75) Inventors: Hannes Wirtl, Schongau (DE); Martin Maichl, Salach (DE)

(73) Assignee: FESTO AG & CO. KG, Esslingen (DE)

(21) Appl. No.: 13/392,753

(22) PCT Filed: Jul. 22, 2010
(86) PCT No.: PCT/EP2010/004491

§ 371 Date: Feb. 27, 2012

(30) Foreign Application Priority Data
Aug. 28, 2009 (DE) DE102009039211.4

(51) Int. Cl. B07C 5/00

(52) U.S. Cl. 209/644

(57) ABSTRACT

The invention relates to a method for sorting and a sorting device for sorting out parts (2) by means of air blasts (12). The sorting device contains at least one air blast generator (8) comprising a diaphragm unit (33) which can be deflected by electric activation and which delimits a work chamber (34) connected to a ejection opening (32). When activated, the diaphragm unit (33) functions as an air displacement unit and produces an active air discharge out of the work chamber (34) through the ejection opening (32) on the basis of the air displacement resulting from said activation. In particular, the air blast has the shape of a toroidal eddy.

The invention relates to a method for sorting out parts by means of air blasts. The invention further relates to a sorting device for sorting out parts by means of air blasts, said sorting device comprising at least one air blast generator having a generator housing in which at least one reversibly deflectable diaphragm unit bounds a working chamber connected to at least one ejection opening, wherein the discharge of an air blast from the working chamber through the ejection opening can be caused by the activation of the diaphragm unit.

A sorting device of this type, which is known from U.S. Pat. No. 5,628,411, comprises an air blast generator with a housing which bounds a housing chamber in which extends a flexible piezoelectric diaphragm unit. The diaphragm unit bounds a working chamber which communicates with an ejection opening leading into the environment and placed opposite the inner orifice of the working chamber. Via a further passage, compressed air can be fed into the working chamber without being able to pass through the ejection opening as long as the diaphragm unit blocks the inner orifice. In order to generate an air blast for discharge, the diaphragm unit is deflected by electric actuation, so that it is lifted off the orifice of the ejection opening and the pressurised air can flow out of the working chamber. The air blast generator therefore has the functionality of a valve, with the diaphragm unit acting as a valve member which allows or prevents a discharge of air depending on its state of activation.

The sorting device is used for a method for sorting out parts by means of air blasts. Falling parts, for example grains of rice, can be checked visually and can be sorted out if a reject is found. For this process, an air blast which blows the reject away is generated by the air blast generator. As this requires a very precise and relatively intensive air blast, the working chamber has to be supplied with compressed air under high excess pressure. The measures required for this are relatively complex and expensive, and the reliable function of the valves involves very strict requirements if leaks and the potentially resulting malfunction of the sorting-out process are to be avoided.

DE 40 30 344 A1 discloses a sorting device wherein pressure surges are generated by electrically triggered pulse generators and directed onto the objects to be sorted through upstream control nozzles having tapered orifices.

DE 38 08 798 A1 discloses a sorting device in which a sorting action is caused by a temporary narrowing of a branch passage, a point of this passage being subjected to short blows by means of a piezoelectric device.

DE 20 2007 001 884 U1 describes a sound wave generator for generating sound waves which are, for example, used for therapeutic purposes. By deflecting a diaphragm bearing against a conical wall, sound or shock waves are generated, which are focussed by a lens which is obviously designed as a solid body onto a focus disposed outside the device. Owing to the deflection of the diaphragm, an air blast is said to be generated, which is however unlikely to find the way to the focus, because it is held back by the lens. Although sound waves can pass through the lens, it does not appear to be suitable for the passage or air.

From WO 2006/083635 A2, a sorter is known which can eject fluid through a piezoelectric crystal. The piezoelectric crystal is placed in a chamber which is fed with the fluid to be ejected.

The present invention is based on the problem of proposing a simple and reliable sorting method which works reliably and is easily operated while involving a minimum of constructive effort.

To solve this problem, the air blasts directed onto the parts to be sorted are, in a sorting method of the type referred to above, generated in the form of toroidal eddies.

In a sorting device of the type referred to above, the problem is solved by providing that the diaphragm unit is designed as an air displacement unit containing a flexible displacement diaphragm which, by means of its activation involving a sudden reduction of the volume of the working chamber, can be deflected to perform an ejection movement, so that it displaces the air forming the air blast actively through the ejection opening from the working chamber in a pulsed manner.

In the sorting device according to the invention, the air blast generator does not necessarily have to rely on pressurised air for its operation, because the ejected air does not derive most of its energy from an external compression process, but directly from the active displacement by the diaphragm unit driven to perform the ejection movement. The sudden deflection of the diaphragm unit causes an intensive air blast which is capable of blowing away and thereby sorting out any unwanted particles. Although it would in principle be possible to supply the working chamber with pre-compressed air, the concept according to the invention offers the advantage that is operative even without having pre-compressed air in the working chamber. If the air blast generator is exclusively operated with air which has not been pre-compressed, the operation becomes particularly advantageous in terms of energy consumption, and there is no leakage flow which could adversely affect the work result. The air blasts which can be generated by the air blast generator are toroidal eddies in particular, which could also be designated as “vortices” and which permit a very precise and concentrated application of air to the parts to be sorted out. The method according to the invention provides for a sorting-out of parts by means of such toroidal eddies, because it has been found that an air blast of this type is very stable and intensive and therefore results in a reliable, individual sorting-out of certain parts even if they move at a high frequency and are very close to one another.

Advantageous further developments of the invention can be derived from the dependent claims.

In the method according to the invention, the air is expediently pressed in a pulsed manner through an ejection opening having a circular cross-section in order to produce the vortex. In this context, it has been found to be expedient if the diameter of the ejection opening, which preferably has a circular cross-section, is at least half as large as a smallest dimension of the part to be sorted out. For sorting out oblong grains of rice, for example, the ejection opening would expediently have a diameter which is at least half the cross-sectional diameter of the grain of rice.

It is further advantageous to actuate, in order to produce the air eddies, a diaphragm unit comprising a flexible displacement diaphragm by means of preferably electric activation pulses in such a way that the resulting deflection of the diaphragm unit causes a pulsed ejection of air due to active air displacement from a working chamber bounded by the diaphragm unit through an ejection opening.

In an expedient variant of the sorting device, the diaphragm unit and the at least one ejection opening are arranged such that, irrespective of the activation state of the diaphragm unit, a connection between the working chamber and the ejection opening is always open. The ejection opening is therefore not closed by the diaphragm unit at any point in time during operation.

In the above embodiment, in particular, it is advantageous if the ejection opening lets air pass in both directions. It then acts not only as an ejection opening, but also as an intake opening through which the diaphragm unit draws air back into the working chamber when returning to its home position after performing an ejection movement. In this way, there is no need for additional openings for feeding air into the working chamber. It would nevertheless in principle be possible to support the intake action of the diaphragm unit by a separate air feed.

If the ejection opening is not used as an intake opening, i.e. if the working chamber is recharged with air by other means, the ejection opening could in principle be provided with a non-return valve to prevent the entry of air and thus the intake of impurities.

The generator housing may have several ejection openings terminating into one and the same working chamber. In order to generate an air blast which is focussed as much as possible, the ejection openings would in this case be placed as close as possible to one another and arranged in such a way that the air is ejected in the same direction from all ejection openings.

A particularly stable and intensive air blast can be generated if, by a suitable design of the ejection opening, a inherently rotating, preferably annular, eddy (vortex) is generated to provide the air blast. This can for example be achieved very easily if the outlet orifice of the ejection opening is sharp-edged. The air blast may in particular be perceived as a torus in which the air rotates in itself within the “annular body”.

The at least one diaphragm unit acting as an air displacement unit may in principle be activated by other means. Electric, fluidic or purely mechanical drive concepts can for example be used, or even combinations thereof. It would for example be conceivable to cause the movement of the diaphragm unit by means of a solenoid device or a pulsed application of fluid power, in particular compressed air.

A particularly recommended drive concept for the diaphragm unit, however, involves a piezoelectric configuration. The deflection of the flexible diaphragm unit is in this case based on the use of the inverse piezoelectric effect. Such a concept allows for a very flat design and therefore extremely compact external dimensions of the air blast generator. In addition, power consumption is very low, and there is very little self-heating.

The diaphragm unit based on the piezoelectric principle preferably comprises a resilient displacement diaphragm supported on the generator housing with its continuous outer edge and at least one piezoelectric transducer securely joined to the displacement diaphragm. If the piezoelectric transducer is electrically activated, the displacement diaphragm deforms at right angles to its main dimensional plane, thereby reducing the volume of the working chamber, with the result that the air contained therein is displaced and ejected into the environment through the ejection opening.

The displacement diaphragm expediently is a thin metal diaphragm. In a piezoelectric drive principle, it can simultaneously be used as an electrode for the piezoelectric transducer.

One and the same working chamber can easily be bounded by several diaphragm units which can be activated simultaneously and in the same direction. In this way, the volume of the air blast as well as the intensity of its ejection can be increased significantly while maintaining compact dimensions.

In a sorting device of a particularly advantageous configuration, the area of the displacement diaphragm, converted to a circular area, has five to twenty times the diameter of the ejection opening with its circular cross-section. The area of the displacement diaphragm is preferably conceived as a circle area from the start, but this is not mandatory. If the displacement diaphragm has a non-circular shape, the diameter to be compared to the diameter of the ejection opening is derived from the diameter of a circle area having the same surface area as the non-circular displacement diaphragm.

The ejection opening with its preferably circular cross-section can also be given a particularly expedient dimension for its diameter. This opening diameter preferably lies in the range between 0.3 times and 3 times of the volume displaced from the working chamber as the diaphragm unit is activated, exponentiated with the factor ⅓.

The concept according to the invention advantageously allows the design of a very flat generator housing. The generator housing expediently bounds a housing chamber with dimensions which are smaller in the axial direction of a main axis than perpendicular thereto, in particular in such a way that the housing chamber has a rectangular cross-section. Within this housing chamber, the diaphragm unit can be arranged with its main dimensional plane at an angle relative to the main axis, so that the housing chamber is divided into two sub-chambers, one of which forms the working chamber, while the other expediently acts as a connecting chamber in which the electric contacting of the diaphragm unit which is required for electric activation takes place.

In combination with a rectangular cross-section of the housing chamber, it is particularly advantageous if the diaphragm unit is installed diagonally. The diaphragm unit then divides the housing cross-section into two sub-chambers having triangular contours.

In a flat generator housing, the at least one ejection opening is expediently provided on the narrow side. It is then in particular perpendicular to the axial direction of the main axis of the housing chamber.

If the generator housing has a flat shape, in particular, several air blast generators can be mounted adjacent to one another in a line to form a generator package with parallel main dimensional planes.

The invention is explained in greater detail below with reference to the accompanying drawing, of which:

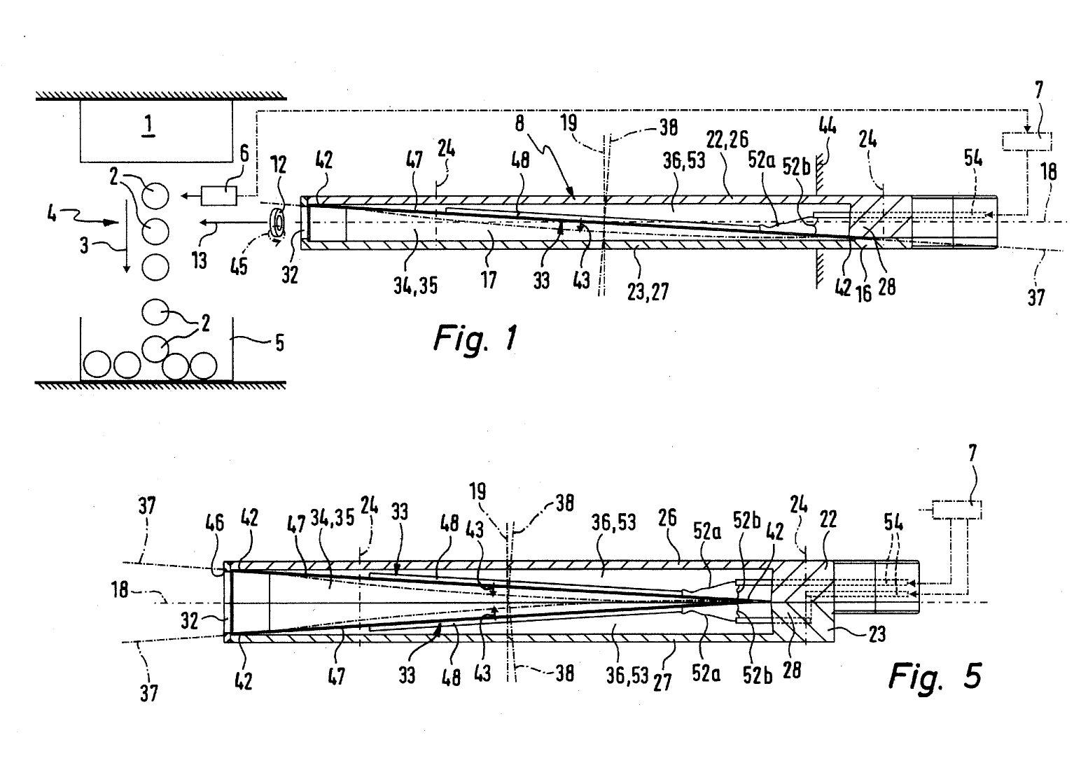

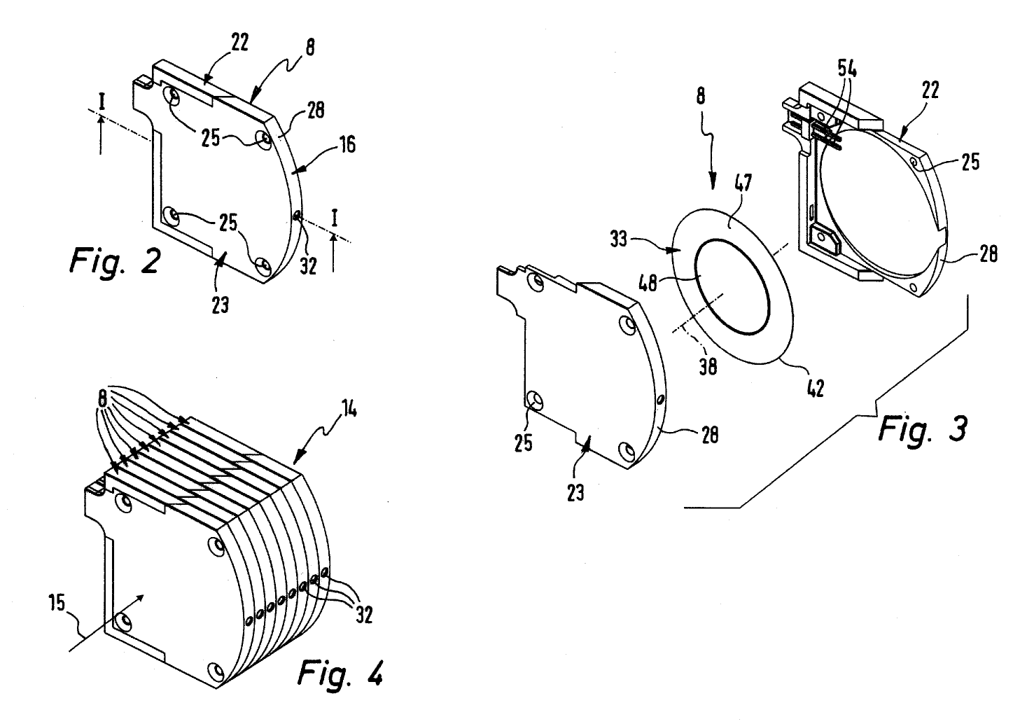

FIG. 1 is a partly diagrammatic representation of an advantageously constructed sorting device according to the invention suitable for the method according to the invention, with a longitudinal section through an advantageous variant of an air blast generator along line I-I from FIG. 2;

FIG. 2 is a perspective view of the air blast generator from FIG. 1;

FIG. 3 is an exploded view of the air blast generator from FIGS. 1 and 2;

FIG. 4 shows a generator package made up from a plurality of air blast generators according to FIG. 2; and

FIG. 5 is a longitudinal section along line I-I from FIG. 2 through a further embodiment of an air blast generator.

FIG. 1 shows a sorting device in the application of the sorting method according to the invention. It comprises a stationary output unit 1 from which parts 2 to be sorted are discharged in a downward direction, in particular involving the force of gravity. The parts 2 fall down in a linear row resembling a chain and in this process pass a sorting zone 4 in accordance with arrow 3. Parts 2 which fall down unimpeded are caught by a collection unit 5 placed at a distance below the output unit 1.

The parts 2 to be sorted are small parts, such as lentils or grains of rice. Most of such parts are of acceptable quality, but there also is a certain number of rejects which do not meet requirements and have to be sorted out.

In a monitoring zone upstream of the sorting zone 4, the parts 2 are checked by a camera or another detecting device 6, and their quality is classified. The result of the check is fed to an electronic control unit 7 of the sorting device, which is connected to an air blast generator 8 placed adjacent to the region where the parts 2 drop. The latter is capable of emitting an air blast diagrammatically indicated by the reference number 12 in an ejection direction 13 when receiving a control command.

The air burst generator 8 is oriented such that the ejection direction 13 is oriented towards the dropping path of the parts 2. By suitable coordination with the control unit 7 and taking into account the rate of fall of the parts 2, air blasts 12 can be generated by the air blast generator 8 in such a way that they hit undesirable rejects and blow them out of the regular dropping path, so that they do not reach the collection unit 5 receiving the acceptable parts.

The sorting device of the illustrated embodiment is fitted with an air blast generator 8 of a particularly advantageous construction, which can also be seen in FIGS. 2 and 3. If required, several such air blast generators 8 can be packaged to form an assembly as shown in FIG. 4, such a generator package 14 comprising a plurality of air blast generators 8 placed next to one another in a line-up direction 15 and detachably joined to one another. FIG. 5 shows an alternative embodiment of an air blast generator 8, and unless stated otherwise, the present explanations apply to this embodiment as well.

The air blast generator 8 has a preferably flat and in particular plate-shaped generator housing 16 with a main dimensional plane 18 and a main axis 19 which is perpendicular thereto. The dimensions in the axial direction of the main axis 19 are significantly smaller than those in the main dimensional plane 18.

The generator housing 16 bounds a cavity in its interior which it hereinafter referred to as housing chamber 17. This also has a flat shape, the dimensions in the axial direction of the main axis 19 being smaller than those perpendicular thereto.

The generator housing 16 preferably consists of first and second housing bodies 22, 23 which are fitted to each other in the axial direction of the main axis 19. In the illustrated embodiments, these are securely joined to each other, preferably in a detachable manner, by screws which are indicated diagrammatically and which are passed through housing holes 25. Other mounting methods can be used, for example bonding or welding.

The housing chamber 17 is bounded by first and second housing main walls 26, 27 arranged opposite and at a distance from each other in the axial direction of the main axis 19 and by a side wall 29 extending frame-like around the main axis 19 between the two housing main walls 26, 27. The first housing main wall 26 is a part of the first housing body 22 and the second housing main wall 27 is a part of the second housing body 23. The side wall 28 is partly a part of the first housing body 22 and partly a part of the second housing body 23. In principle, the side wall 28 could be provided on one housing body only; in this case, the other housing body would be designed as a simple plate-shaped cover.

The side wall 28 has an opening at one point, which opening forms an ejection opening 32 to be explained in detail below. The ejection opening 32 establishes a direct connection between the housing chamber 17 and the surroundings of the generator housing 16, i.e. the atmosphere. The ejection opening 32 expediently has a round, in particular circular, cross-section.

The interior of the housing chamber 17 accommodates at least one flexible diaphragm unit 33. In the second embodiment according to FIG. 5, two diaphragm units 33 are provided in the housing chamber 17, while the other embodiment comprises only a single diaphragm unit 33 in the housing chamber 17.

Each diaphragm unit 33 bounds a working chamber 34 formed in the interior of the generator housing 16. The working chamber 34 is preferably represented by a first of two sub-chambers 35, 36 into which the housing chamber 17 is divided in a gas-tight manner by the respective diaphragm unit 33. The diaphragm unit 33 therefore acts as a partition between a first and a second sub-chamber 35, 36 of the housing chamber 17.

In the embodiment shown in FIGS. 1 to 4, the housing chamber 17 has a total of only two sub-chambers 35, 36. In the embodiment of FIG. 5, the dual diaphragm units are arranged such that each of them separates an independent second sub-chamber 36, but there is only one working chamber 34, which is bounded by both diaphragm units 33 at the same time.

The position of the diaphragm unit(s) 33 is chosen such that the ejection opening 32 communicates with the working chamber 34.

The diaphragm unit 33 is a flat, preferably plate- or disc-shaped, structure. Its normal axis, which is perpendicular to its main dimensional plane 37, is indicated by dot-dash lines at 38.

In principle, the diaphragm unit 33 could be arranged in the housing chamber 17 in any orientation. In an expedient orientation, however, its main dimensional plane 37 extends transverse to the main axis 19, its outer edge section 42 coming to lie in the region of the side wall 28 all round. In this way, a diaphragm unit 33 can be used which has a base area which at least substantially corresponds to the base area of the housing chamber 17 in the region of the two housing main walls 26, 27.

In the region of its outer edge section 42, the diaphragm unit 33 is secured to the wall of the generator housing 16 in a gas-tight manner. It may for example be held on the generator housing 16 by means of an elastic adhesive or using an elastic sealing compound. By means of activation impulses delivered by the electronic control unit 7, the diaphragm unit 33 can be controlled such that it is deflected from a substantially flat home position adopted in the deactivated state—indicated by solid lines in FIGS. 1 and 5—to an activated position indicated by a dot-dash line while performing an ejection movement 43 indicated by an arrow. Following this, the diaphragm unit 33 returns to its home position in a return movement. The actuation of the diaphragm unit 33 therefore involves a reversible, elastic deformation process.

Owing to its deformation, the diaphragm unit 33 reduces the volume of the working chamber 34 during its ejection movement 43. As a result, air is displaced from the working chamber 34 through the ejection opening 32 into the environment. Owing to the fact that the diaphragm unit 33 is deformed suddenly, this results in the air blast 12 referred to above.

Depending on the frequency with which the diaphragm unit 33 is activated and deactivated, the frequency with which the air blasts 12 are generated can be influenced. At a very high excitation frequency, a quasi-continuous air jet can, if required, be produced from a plurality of successive air blasts 12.

The diaphragm unit 33 obviously acts as an air displacement unit which actively displaces air from the working chamber through the ejection opening 32 during its ejection movement 43.

The ejection opening 32 expediently has a circular cross-section. Its diameter “D” is preferably calculated from the formula

D=a·V^{1/3},

wherein “a” is a numeric value between 0.3 and 3, including range limits, and “V” is the volume displaced from the working chamber by the diaphragm unit 33 as it is activated.

The air blast generator 8 is arranged such and—using fixing means 44 indicated diagrammatically—secured such that the ejection opening 32 points towards the falling parts 2. The orientation of the ejection opening 32 is therefore predetermined by the ejection direction 13.

The diaphragm unit 33 is preferably arranged in the generator housing 16 in such a way that its actuation state has no effect on the size of the open cross-section of the ejection opening 32. There is therefore a permanently open connection between the working chamber 34 and the ejection opening 32 and the surroundings of the generator housing 16 respectively.

Quite apart from that, no means are expediently provided for even a temporary closing of the ejection opening 32. As a result, the ejection opening 32 additionally acts as an intake opening when the diaphragm unit 33 performs its return movement. In this case, the diaphragm unit 33 can act similar to a pump element which draws ambient air through the ejection opening 32 into the working chamber 34. In this way, the working chamber 34 is re-charged with air without any outside help, and the next ejection movement 43 can follow effectively without any delay.

To support the recharging process, the wall of the generator housing 16 could be provided with at least one intake opening in addition to the ejection opening 32, through which compressed air is fed in. In this case, a control valve could be assigned to the ejection opening 32, in particular a non-return valve which would permit the discharge, but not the entry, of air. Such a valve would in particular offer the advantage of acting as a barrier against the entry of impurities. The embodiment without an extraneous air supply, on the other hand, has the advantage of not requiring any local air supply, so that the air blast generator 8 can operate with electric energy only.

Both embodiments are provided with a single ejection opening 32. In principle, however, a plurality of ejection openings 32 of a smaller cross-section could be provided, particularly if distributed over a very small area.

The sorting device is particularly effective owing to the fact that the air blast discharged through the ejection opening 32 is a rotating, toroidal eddy as indicated in FIG. 1 by an arrow at 45. This results in very stable and precise air pulses. Such an eddy of air can also be designated as a “vortex”.

A very simple method for generating these vortices is created by giving the outlet orifice 46 of the ejection opening 32 sharp edges in the transitional region towards the outer surface of the generator housing 16.

A piezoelectric configuration is in particular to be recommended for the diaphragm unit 33, because this allows for a flat construction. The desired deflection of the diaphragm unit 33 is based on the use of the inverse piezoelectric effect. Other designs are conceivable in principle. The diaphragm unit could for example be electrically activated for deflection in a different way, for instance by electromagnetically generated actuating forces. A purely mechanical actuation and/or an actuation by fluid power could also be implemented.

In both embodiments, the diaphragm unit 33 has a piezoelectric configuration. For this purpose, there is preferably provided a flexible, in particular spring-elastic, displacement diaphragm 47, which forms the outer edge section 42 and is fitted with a piezoelectric transducer 48 in the central region of one of its large-area sides. The displacement diaphragm 47, like the piezoelectric transducer 48, preferably has a circular external contour. Both components are therefore in particular disc-shaped and arranged to be concentric relative to each other.

If a drive voltage is applied to the piezoelectric transducer 48 via first and second contact elements 52a, 52b, it contracts diametrically while becoming thicker and effects a doming of the displacement diaphragm 47, which is securely joined thereto over a large area. This results in the ejection movement 43 described above.

If the piezoelectric transducer 48 is discharged, the displacement diaphragm 47 is returned to its home position owing to its spring-elastic properties. Each ejection movement 43 causes an air blast 12.

The area of the displacement diaphragm 47, converted to a circular area, has five to twenty times the diameter of the ejection opening 32 with its circular cross-section. If the displacement diaphragm 47 is circular, its diameter is therefore preferably 5 to 20 times that of the ejection opening 32. If the displacement diaphragm is non-circular, the diameter which is comparable to the diameter of the ejection opening corresponds to the diameter of a circle area having the same surface area as the non-circular displacement diaphragm 47.

This expedient dimensioning is unaffected by the activation principle of the diaphragm unit and applies in particular even if the diaphragm unit does not comprise a piezoelectric transducer.

As a whole, it is expedient if the diameter of the ejection opening 32 with its preferably circular cross-section is at least half as large as the smallest dimension of the parts to be sorted. If, as in the illustrated embodiment, the parts 2 to be sorted are spherical, the diameter of the ejection opening 32 should be at least equal to the radius of the spherical parts.

If the displacement diaphragm 47 is made of metal as in the illustrated embodiment, it can directly act as one of the electrodes of the piezoelectric transducer 48. As a result, one contact element 52b can be mounted directly on the displacement diaphragm 47. The second electrode is expediently located on the rear side of the piezoelectric transducer 48 opposite the displacement diaphragm 47. The other contact element 52a is connected thereto.

The piezoelectric transducer 48 is expediently mounted on the side of the displacement diaphragm 47 which faces the second sub-chamber 36. The second sub-chamber 36 can therefore be used as a connecting chamber 53, where all connecting measures which have to be taken with respect to the diaphragm unit 33 in the interior of the generator housing 16 are concentrated. The contact elements 52a, 52b are electrically contacted to the diaphragm unit 33 within the connecting chamber 53.

Even if no piezoelectric drive principle is used for the activation of the diaphragm unit 33, the second sub-chamber 36 can advantageously be used for measures for driving or activating the diaphragm unit 33. In a fluidic drive concept, the second sub-chamber 36 could be used for causing a pulsed application of fluid pressure to the diaphragm unit 33. In this case, at least one control passage for the supply and removal of the operating fluid would terminate into the second sub-chamber 36.

For the connection of the electronic control unit 7, one or more connecting contacts 54 are provided, which pass through the wall of the generator housing 16 and are contacted by the contact elements 52a, 52b referred to above, the latter being flexible so that they can follow the movement of the diaphragm unit 33 without being damaged.

FIGS. 1 and 5 show clearly that the dimensions of the housing chamber 17, like those of the generator housing as a whole, are expediently smaller in the axial direction of the main axis 19 than in the direction perpendicular thereto, i.e. in the direction of the main dimensional plane 18. This results in the above-mentioned desirable flat construction, so that the housing chamber in particular has a rectangular cross-section in a plane defined by the main axis 19 and the transverse axis which is perpendicular thereto. The shorter sides of this rectangle—represented by the side wall 28 in the illustrated embodiment—extend parallel to the main axis 19, while the longer sides extend parallel to the main dimensional plane 18.

This arrangement results in an optimum orientation of the diaphragm unit 33, if its main dimensional plane 37 is inclined with respect to the main axis 19 of the generator housing 16. The normal axis 38 referred to above is in this case not parallel to the main axis 19, but extends at an angle thereto.

If the housing chamber 17 is equipped with only one diaphragm unit 33, an arrangement is to be recommended wherein the diaphragm unit 33 extends between two diagonally opposite corner regions of the rectangular cross-section of the housing chamber 17 (FIG. 1). The cross-section of the housing chamber 17 is thereby divided into two sub-chambers 35, 36, each having the shape of a right-angled triangle, their cross-sectional hypotenuses coinciding with the main dimensional plane 37 of the diaphragm unit 33. The ejection opening 32 is oriented at right angles to the main axis 19.

If, as shown in FIG. 5, the housing chamber 17 accommodates two diaphragm units 33 at the same time, an orientation with opposing inclination is recommended. In the region of the ejection opening 32, the two diaphragm units 33 arranged opposite each other in the axial direction of the main axis 19 are farthest apart, approaching each other from there towards the opposite rear side of the housing chamber 17. This results between the two diaphragm units 33 in a working chamber 34 having the cross-section of an isosceles triangle, the equal sides of the triangle being defined by a diaphragm unit 33 each. The two second sub-chambers 36 act as connecting chambers 53 for the electric contacting of the associated piezoelectric transducer 48.

The electric activation of the two diaphragm units 33 is preferably always effected simultaneously and equidirectionally, so that both diaphragm units 33 are simultaneously driven to perform the ejection movement 43 and a greater volume of air is displaced to generate the air blast 12 than in a design with only one diaphragm unit 33.

The flat shape of the generator housing 16 makes the air blast generator 8 suitable for packaging as shown in FIG. 4. The air blast generators 8 are here mounted in line with parallel main dimensional planes 18 and can for example be clamped together to form a generator package 14 by using the mutually aligned screw holes 25.

To summarise, one of the essential advantages of the illustrated embodiments lies in the fact that there is no need for pneumatic connections for the supply of external air, because each air pulse is generated independently. The air blast generator operates without friction and therefore extremely fast. Very flat dimensions are possible, for example an overall height of only 4 mm in the axial direction of the main axis 19. In piezoelectric operation, only a low drive power is required, so that self-heating remains at a low level. If the air blasts 12 are generated as vortices, they are very precise and intensive. Following the required pre-assembly, the entire air blast generator 8 can essentially be assembled from only three or four components, i.e. the two housing bodies 22, 23 and one or two diaphragm unit(s) 33.

1. A method for sorting out parts by means of air blasts, wherein the air blasts directed onto the parts to be sorted out are generated in the form of toroidal eddies.

2. A method according to claim 1, wherein the air for the generation of the eddying air blasts is pushed in a pulsed manner through an ejection opening having a circular cross-section.

3. A method according to claim 2, wherein the diameter of the ejection opening is at least half as large as a smallest dimension of the part to be sorted out by the application of an air blast.

4. A method according to claim 1, wherein a diaphragm unit comprising a flexible displacement diaphragm is driven, using electric activation pulses, in such a way that its resulting deflection effects by active displacement of air a pulsed ejection of air from a working chamber through an ejection opening.

5. A sorting device for sorting out parts by means of air blasts, comprising at least one air blast generator having a generator housing in which at least one reversibly deflectable diaphragm unit bounds a working chamber connected to at least one ejection opening wherein the ejection of an air blast from the working chamber through the ejection opening can be caused by the activation of the diaphragm unit, and wherein the diaphragm unit forms an air displacement unit comprising a flexible displacement diaphragm, which can be deflected by activation for a sudden reduction of the volume of the working chamber in order to perform an ejection movement, so that it actively displaces in a pulsed manner the air forming the air blast from the working chamber through the ejection opening.

6. A sorting device according to claim 5, wherein the diaphragm unit and the ejection opening are arranged such that the connection between the working chamber and the ejection opening is always open, irrespective of the activation state of the diaphragm unit.

7. A sorting device according to claim 5, wherein the ejection opening allows the passage of air in both directions and simultaneously forms an intake opening through which air flows or is drawn from the outside into the working chamber when the diaphragm unit performs a return movement opposed to the ejection movement.

8. A sorting device according to claim 5, wherein precisely one ejection opening terminating into the working chamber is provided.

9. A sorting device according to claim 5, wherein the ejection opening has a sharp-edged outlet orifice such that the ejection opening shapes the emerging air blast into a toroidal eddy (vortex).

10. A sorting device according to claim 5, wherein the at least one diaphragm unit is designed for electric activation.

11. A sorting device according to claim 10, wherein the diaphragm unit has a piezoelectric configuration.

12. A sorting device according to claim 10, wherein the diaphragm unit comprises a spring-elastic displacement diaphragm supported on the generator housing with its outer edge section and a piezoelectric transducer securely connected to the displacement diaphragm.

13. A sorting device according to claim 11, wherein the displacement diaphragm is made of metal and also forms an electrode of the piezoelectric transducer.

14. A sorting device according to claim 5, wherein the displacement diaphragm has an inclined orientation in the interior of a housing chamber of the generator housing, lying diagonal therein, wherein it divides the housing chamber in a gas-tight arrangement into a first sub-chamber forming the working chamber and a second sub-chamber, the second sub-chamber being used for measures for driving the diaphragm unit.

15. A sorting device according to claim 5, wherein the generator housing encloses a housing chamber, the dimensions of which in the axial direction of a main axis are smaller than those perpendicular thereto, wherein the diaphragm unit has an inclined main dimensional plane with respect to the main axis in the housing chamber and divides the housing chamber into two sub-chambers one of which forms the working chamber.

16. A sorting device according to claim 15, wherein the housing chamber has a rectangular cross-section, the shorter sides of which extend parallel to the main axis and the longer sides of which extend at right angles to the main axis, the normal axis of the diaphragm unit, which is perpendicular to the main dimensional plane, extending at an angle to the main axis.

17. A sorting device according to claim 16, wherein the main dimensional plane of the diaphragm unit extends between two diagonally opposite corner regions of the rectangular cross-section of the housing chamber.

18. A sorting device according to claim 14, wherein the sub-chamber of the housing chamber which is opposite the working chamber forms a connecting chamber in which the electric connection measures taken with respect to the diaphragm unit are located, the working chamber not containing any such electric connection measures.

19. A sorting device according to claim 5, wherein the ejection opening is oriented transversely to the direction of the ejection movement of the diaphragm unit.

20. A sorting device according to claim 5, wherein the surface area of the displacement diaphragm, converted to a circle area has five to twenty times the diameter of the ejection opening with its circular cross-section.

21. A sorting device according to claim 5, wherein the diameter “D” of the ejection opening with its circular cross-section fulfils the condition
D=a·V^{1/3},
wherein “a” is a numeric value between 0.3 and 3 and “V” is the volume displaced from the working chamber by the diaphragm unit as it is activated.

22. A sorting device according to claim 5, wherein the generator housing externally has a flat shape and smaller external dimensions in the direction of a main axis than perpendicular thereto.

23. A sorting device according to claim 5, wherein the working chamber is bounded by several diaphragm units which can be activated simultaneously and in the same sense.

24. A sorting device according to claim 23, wherein the working chamber is located between two diaphragm units which lie opposite each other and are inclined relative to each other while enclosing an acute angle.

25. A sorting device according to claim 5, further comprising an electronic control unit for the activation of the at least one diaphragm unit of the at least one air blast generator.

26. A sorting device according to claim 25, further comprising a detection unit connected to the electronic control unit for checking the parts to be sorted.

27. A sorting device according to claim 5, further comprising at least one generator package made up from a plurality of air blast generators fitted to one another in a line-up direction, the ejection openings of all air blast generators having an identical orientation.
